(19) United States
(12) Patent Application Publication
(10) Pub. No.: US 2016/0001521 A1
(43) Pub. Date: Jan. 7, 2016

(54) CURVED DISPLAY DEVICE AND METHOD OF FABRICATING THE SAME

(71) Applicant: SAMSUNG DISPLAY CO., LTD., Yongin-City (KR)

(72) Inventors: Katsuhiko TANAKA, Cheonan-si (KR); Soo Chan LEE, Asan-si (KR); Jae Young KIM, Asan-si (KR); Dong Jin OK, Hwaseong-si (KR); Se Mi LEE, Incheon (KR); Jin Suk LEE, Yongin-si (KR)

(21) Appl. No.: 14/620,676

(22) Filed: Feb. 12, 2015

(30) Foreign Application Priority Data
Jul. 2, 2014 (KR) 10-2014-0082492

(51) Int. Cl. B32B 3/28; B32B 7/12; B32B 3/14; B32B 37/10

(52) U.S. Cl. CPC B32B 3/28; B32B 37/10; B32B 7/12; B32B 3/14; B32B 2457/202; B32B 2457/206

(57) ABSTRACT

A curved display device and a method of fabricating the same the curved display device including a display panel including a curved portion and a flat portion; a cover window having a same shape as the display panel, the cover window being bonded to the display panel; and an adhesive film between the display panel and the cover window, wherein the adhesive film includes a first adhesive portion attached to at least the curved portion of the display panel, and a second adhesive portion attached to the flat portion of the display panel, the second adhesive portion being a separate piece from the first adhesive portion.

### CROSS-REFERENCE TO RELATED APPLICATION

Korean Patent Application No. 10-2014-0082492, filed on Jul. 2, 2014, in the Korean Intellectual Property Office, and entitled: “Curved Display Device and Method of Fabricating the Same,” is incorporated by reference herein in its entirety.

### BACKGROUND

1. Field

Embodiments relate to a curved display device and a method of fabricating the same.

2. Description of the Related Art

A variety of display devices, e.g., an organic light-emitting display (OLED) device and a liquid crystal display (LCD) device, have been employed in the monitors of computers, mobile terminals, and various other information devices.

A display device may include a display panel, which displays an image, a cover window, which is bonded onto a surface of the display panel where an image is displayed and protects the display panel, and an adhesive film, which is interposed between the display panel and the cover window and bonds the display panel and the cover window together.

The display panel and the cover window may be bonded together by a vacuum bonding process or a pressing process involving the use of a roller.

### SUMMARY

Embodiments are directed to a curved display device and a method of fabricating the same.

The embodiments may be realized by providing a curved display device including a display panel including a curved portion and a flat portion; a cover window having a same shape as the display panel, the cover window being bonded to the display panel; and an adhesive film between the display panel and the cover window, wherein the adhesive film includes a first adhesive portion attached to at least the curved portion of the display panel, and a second adhesive portion attached to the flat portion of the display panel, the second adhesive portion being a separate piece from the first adhesive portion.

The first adhesive portion and the second adhesive portion may form an interface therebetween.

The interface may overlap with a boundary between the curved portion of the display panel and the flat portion of the display panel.

The interface may overlap with the flat portion at an edge portion of the flat portion that adjoins the curved portion.

The first adhesive portion and the second adhesive portion have a gap therebetween.

The adhesive film may be an optical clear adhesive tape.

The display panel may be a liquid crystal display panel or an organic light-emitting display panel.

The embodiments may be realized by providing a method of fabricating a curved display device, the method including placing a cover window on a stage, the cover window including a curved portion and a flat portion; placing a first holder over the stage, the first holder holding a first adhesive portion; attaching the first adhesive portion onto at least the curved portion of the cover window by moving a roller in a first direction, the first direction being parallel to a direction in which the curved portion and the flat portion are connected together; placing a second holder over the stage, the second holder holding a second adhesive portion; and attaching the second adhesive portion onto the flat portion by moving the roller in the first direction.

The method may further include pressing the first adhesive portion and the second adhesive portion where the first adhesive portion and the second adhesive portion face each other, the pressing including moving a ball in a second direction perpendicular to the first direction, after attaching the second adhesive portion onto the flat portion.

The ball may have a smaller curvature than the curved portion.

A moving speed of the roller during attaching the first adhesive portion to the cover window may be slower than the moving speed of the roller during attaching the second adhesive portion to the cover window.

A top surface of the stage may have a same shape as a top surface and a bottom surface of the cover window.

Attaching the first adhesive portion and the second adhesive portion to the cover window may form an interface between the first adhesive portion and the second adhesive portion.

The interface may overlap with a boundary between the curved portion and the flat portion.

The interface may overlap with the flat portion at an edge portion of the flat portion that adjoins the curved portion.

Attaching the first adhesive portion and the second adhesive portion to the cover window may form a gap between the first adhesive portion and the second adhesive portion.

The first adhesive portion and the second adhesive portion may be optical clear adhesive tapes.

The method may further include attaching a touch panel or a display panel onto the first adhesive portion and the second adhesive portion.

The display panel may be a liquid crystal display panel or an organic light-emitting display panel.

### BRIEF DESCRIPTION OF THE DRAWINGS

Features will be apparent to those of skill in the art by describing in detail exemplary embodiments with reference to the attached drawings in which:

FIG. 1 illustrates a cross-sectional view of a curved display device according to an exemplary embodiment.

FIG. 2 illustrates a cross-sectional view of a curved display device according to another exemplary embodiment.

FIGS. 3 to 9 illustrate diagrams of stages in a method of fabricating the curved display device of FIG. 1, according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

It will also be understood that when a layer is referred to as being “on” another layer or substrate, it can be directly on the other layer or substrate, or intervening layers may also be present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer, or section discussed below could be termed a second element, component, region, layer, or section without departing from the teachings of the present invention.

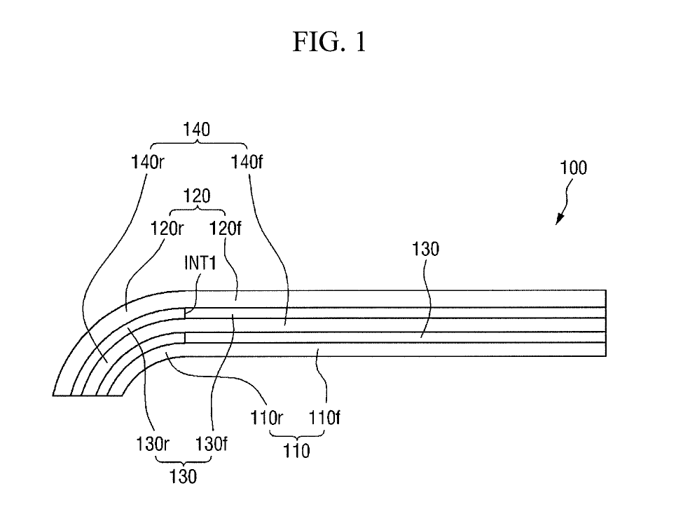

FIG. 1 illustrates a cross-sectional view of a curved display device according to an exemplary embodiment.

Referring to FIG. 1, a curved display device 100 may include a display panel 110, which may be at least partially curved (e.g., at an end thereof), a cover window 120, and an adhesive film 130.

The display panel 110 may include a flexible film, and may have a curved portion 110r and a flat portion 110f. The display panel 110 may be a panel for use in a display device (e.g. an organic light-emitting display device or a liquid crystal display (LCD) device) for displaying an image.

The cover window 120 may have a same shape as the display panel 110. For example, the cover window 120 may include a curved portion 120r and a flat portion 120f. For example, the cover window 120 may have a congruent or corresponding shape with respect to the display panel 110. The cover window 120 may allow an image that is displayed on the display panel 110 to be seen therethrough, and may protect the display panel 110 from external shock. The cover window 120 may be foamed of a rigid material, e.g., glass or plastics.

A touch panel 140 may be between the display panel 110 and the cover window 120, and may detect a touch operation performed by a user. The touch panel 140 may have a same shape as the display panel 110. For example, the touch panel 140 may include a curved portion 140r and a flat portion 140f. For example, the touch panel 140 may have a congruent or corresponding shape with respect to the display panel 110

The adhesive film 130 may be between the display panel 110 and the cover window 120 and may bond the display panel 110 and the cover window 120 together. The adhesive film 130 may be an optical clear adhesive (OCA) tape. When the touch panel 140 is included between the display panel 110 and the cover window 120, the adhesive film 130 may be between the display panel 110 and the touch panel 140 and between the touch panel 140 and the cover window 120, respectively. For example, the adhesive film 130 may include an adhesive film 130 between the display panel 110 and the touch panel 140 and may include another adhesive film 130 between the touch panel 140 and the cover window 120.

The adhesive film 130 may include a first adhesive portion 130r and a second adhesive portion 130f, which may not be formed in one body with each other, but rather may be formed as separate elements. For example, the first adhesive portion 130r may be a separate and/or independent piece with respect to the second adhesive portion 130f.

The first adhesive portion 130r of the adhesive film 130 may be attached to the curved portion 110r of the display panel 110 and/or the curved portion 120r of the cover window 120, and the second adhesive portion 130f of the adhesive film 130 may be attached to the flat portion 110f of the display panel 110 and/or or the flat portion 120f of the cover window 120. As noted above, the second adhesive portion 130f may be a separate piece from the first adhesive portion 130r of the adhesive film 130. For example, the first adhesive portion 130r and the second adhesive portion 130f of the adhesive film 130 may be provided as separate elements, and may be attached to the cover window 120 or the display panel 110 separately from each other (e.g., in separate processes) in consideration that the pressure applied by a roller (see 30, FIG. 5) may vary from the curved portion 120r to the flat portion 120f of the cover window 120.

An interface INT1 may be between the first adhesive portion 130r and the second adhesive portion 130f of the adhesive film 130. The interface INT1 may overlap with, overlie, or be aligned with a boundary between the curved portion 110r and the flat portion 110f of the display panel 110 and/or a boundary between the curved portion 120r and the flat portion 120f of the cover window 120. In an implementation, a fine or negligible gap may exist between the first adhesive portion 130r and the second adhesive portion 130f of the adhesive film 130. In an implementation, the interface INT1 may be aligned along a line on the display panel 110 or the cover window 120 in which the line is where the curved portion transitions to the flat portion, e.g., the curved portion is at one side of the line and the flat portion is at another side of the line. For example, the first adhesive portion 130r may cover only the curved portion and the second adhesive portion 130f may cover only the flat portion.

If an adhesive film were to be formed as one piece and attached onto the cover window having the curved portion and the flat portion, bubbles could be generated between the cover window and the adhesive film, e.g., at the boundary between the curved portion and the flat portion, due to a difference between the pressure applied to the curved portion by the roller and the pressure applied to the flat portion by the roller.

According to an embodiment, e.g., as illustrated in FIG. 1, the first adhesive portion 130r and the second adhesive portion 130f of the adhesive film 130 may be separately attached onto (e.g., may be separate pieces on) the curved portion 120r and the flat portion 120f of the cover window 120, respectively, or the curved portion 110r and the flat portion 110f, respectively, of the display panel 110. Accordingly, the generation of bubbles between each of the adhesive films 130 and the cover window 120 or the display panel 110 may be reduced and/or prevented.

According to embodiment, e.g., as illustrated in FIG. 1, the curved display device 100 may help reduce smudges caused by the generation of bubbles, and may thus help improve the quality of display.

A curved display device according to another embodiment will hereinafter be described.

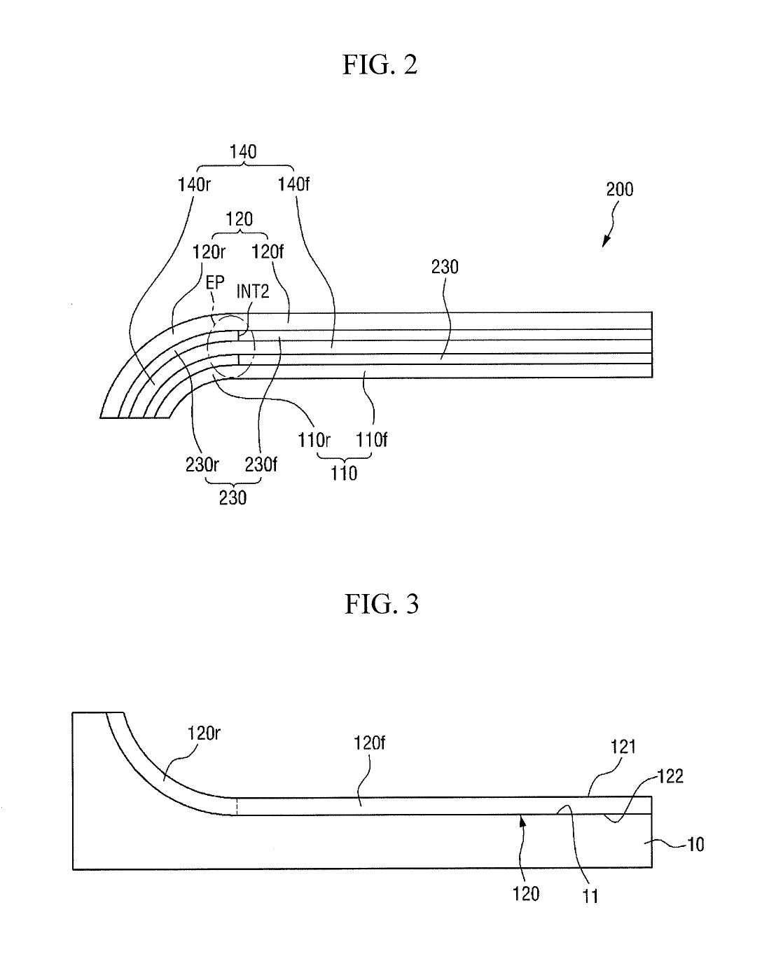

FIG. 2 illustrates a cross-sectional view of a curved display device according to another exemplary embodiment.

A curved display device 200 according to the present embodiment may be substantially the same as the curved display device 100 described above except for the adhesive film 230, and thus will hereinafter be described, focusing mainly on the adhesive film 230.

Referring to FIG. 2, the curved display device 200 may include the display panel 110, which is at least partially curved (e.g., at an end thereof, the cover window 120, and the adhesive film 230.

The adhesive film 230 may not be formed as one piece or a single piece. For example, the adhesive film 230 may include a first adhesive portion 230r and a second adhesive portion 230f. For example, the first adhesive portion 230r and the second adhesive portion 230f may be separate and/or independent pieces with respect to one another. The adhesive film 230 may perform similar functions to those of the adhesive film 130 described above.

The display panel 110 may include the curved portion 110r and the flat portion 110f, and the cover window 120 may include the curved portion 120r and the flat portion 120f. An interface INT2 between the first adhesive portion 230r and the second adhesive portion 230f of the adhesive film 230 may overlap with, overlie, or be aligned with an edge portion EP of the flat portion 110f (that adjoins the curved portion 110r), on the flat portion 110f, and/or an edge portion EP of the flat portion 120f (that adjoins the curved portion 120r), on the flat portion 120f. As a result, the first adhesive portion 130r of the adhesive film 130 may be attached to the cover window 120 or the display panel 110 with the use of a roller such that an end of the first adhesive portion 130r may overlap with or overlie the flat portion 120f of the cover window 120. Accordingly, the adhesive film 130 may be be attached onto the cover window 120 and the display panel 110, respectively, with the ends of the first adhesive portions 130r thereof at a stable location, and efficiency of attaching the first adhesive portion 130r and the second adhesive portion 130f of the adhesive film 130 onto the cover window 120 or the display panel 110 may be improved. For example, the interface INT2 may be spaced apart from the curved portion. In an implementation, the interface INT2 may be spaced apart from a line on the display panel 110 or the cover window 120, in which the line is where the curved portion transitions to the flat portion, e.g., the curved portion is at one side of the line and the flat portion is at another side of the line. For example, the interface INT2 may be surrounded by the flat portion such that the flat portion is between the interface INT2 and the line representing the transition between the curved portion and the flat portion. For example, the first adhesive portion 230r may cover the curved portion and at least a part of the flat portion and/or the second adhesive portion 230f may only cover a part of the flat portion.

According to the present embodiment, e.g., as illustrated in FIG. 2, the interface INT2 between the first adhesive portion 230r and the second adhesive portion 230f of the adhesive film 230 may overlap with or overlie the edge portion EP of the flat portion 110f of the display panel 110 or the edge portion EP of the flat portion 120f of the cover window 120. Therefore, the efficiency of attaching the adhesive film 230 onto the cover window 120 or the display panel 110 may be improved.

A method of fabricating the curved display device 100, according to an exemplary embodiment, will hereinafter be described.

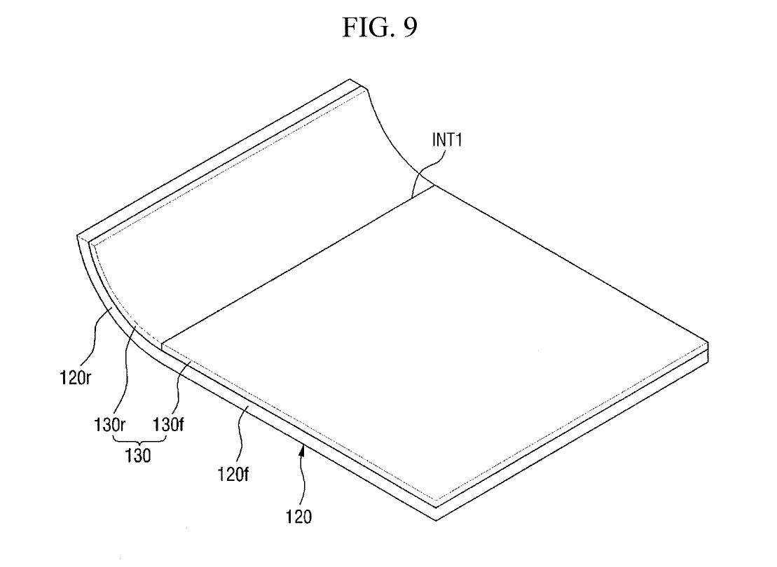

FIGS. 3 to 9 illustrate diagrams showing stages in a method of fabricating the curved display device of FIG. 1, according to an exemplary embodiment.

Referring to FIG. 3, a cover window 120, which includes the curved portion 120r and the flat portion 120f, may be placed on a stage 10. A top surface 11 of the stage 10 may have the same shape as a top surface 121 and a bottom surface 122 of the cover window 120. The stage 10 may include a vacuum suction hole (not illustrated) for fixing or holding the cover window 120 in place by vacuum suction.

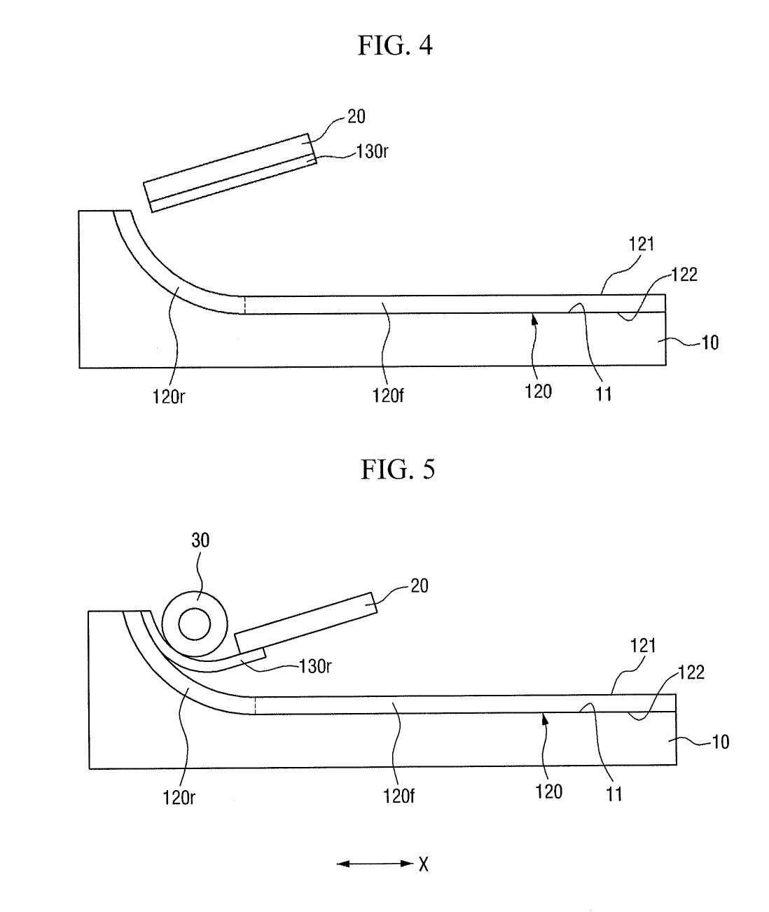

Referring to FIG. 4, a first holder 20 (that holds a first adhesive portion 130r of an adhesive film 130) may be placed over the stage 10. The first holder 20 may include a vacuum suction hole (not illustrated) for holding the first adhesive portion 130r by vacuum suction. A driving unit (not illustrated), e.g., a motor, may be connected to the first holder 20 to horizontally or vertically move the first absorption member 20 during the bonding of the curved portion 120r and the first adhesive portion 130r.

Referring to FIG. 5, the first adhesive portion 130r may be bonded onto at least the curved portion 120r by moving a roller 30 in a first direction X, which is parallel to a direction in which the curved portion 120r and the flat portion 120f are connected together. During the bonding of the first adhesive portion 130r to the curved portion 120r with the roller 30, the vacuum suction degree of the first holder 20 may be controlled (e.g., reduced) such that the first adhesive portion 130r may slide off of the first holder 20. Another driving unit (not illustrated), e.g., a motor, may be connected to the roller 30 in order to move the roller 30 to bond (e.g., to press) the curved portion 120r and the first adhesive portion 130r together. The roller 30 is illustrated in FIG. 5 as being moved in a direction from the curved portion 120r toward the flat portion 120f. In an implementation, the roller 30 may be moved in a direction from the flat portion 120f to the curved portion 120r. For example, the first direction X may be the direction from the curved portion 120r toward the flat portion 120f or from the flat portion 120f to the curved portion 120r.

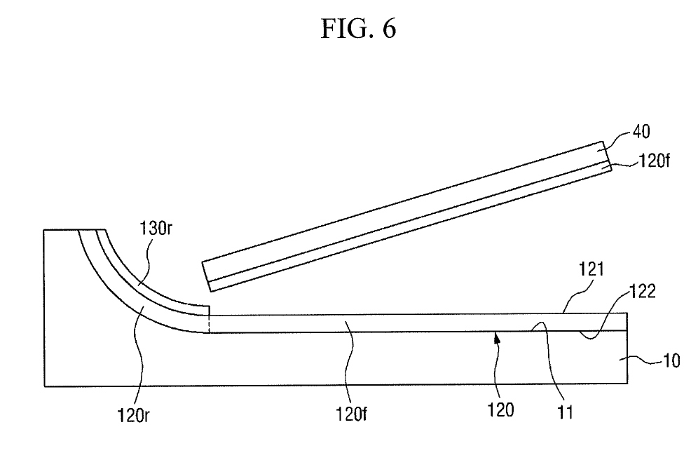

Referring to FIG. 6, a second holder 40 (that holds a second adhesive portion 130r) may be placed over the stage 10. The second holder 40 may include a vacuum suction hole (not illustrated) for holding the second adhesive portion 130f by vacuum suction. A driving unit (not illustrated), e.g., a motor, may be connected to the second holder 40 in order to horizontally or vertically move the second holder 40 during the bonding of the flat portion 120f and the second adhesive portion 130f.

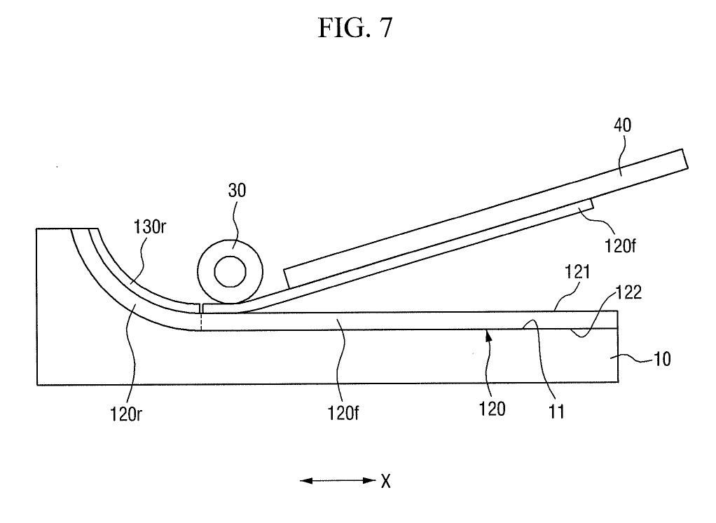

Referring to FIG. 7, the second adhesive portion 130f may be bonded onto the flat portion 120r by moving the roller 30 in the first direction X. In an implementation, a gap may be formed between the first adhesive portion 130r and the second adhesive portion 130f when applying the adhesive film 130. During the bonding of the second adhesive portion 130f to the flat portion 120f with the roller 30, the vacuum suction capacity of the second holder 40 may be controlled (e.g., reduced) such that the second adhesive portion 130f may slide off of the second holder 40. As illustrated in FIG. 7, the roller 30 may move in a direction from the curved portion 120r to the flat portion 120f. In an implementation, the roller 30 may move in a direction from the flat portion 120f to the curved portion 120r. The driving unit connected to the roller 30 may move the roller 30 during the bonding of the flat portion 120f and the second adhesive portion 130f.

The roller 30 may be moved more slowly when bonding the first adhesive portion 130r to the cover window 120 than when bonding the second adhesive portion 130f to the cover window 120, e.g., to delicately press the first adhesive portion 130r against the curved portion 120r and thus to properly attach the first adhesive portion 130r onto the curved portion 120r. Accordingly, generation of bubbles may be reduced and/or prevented in the area of the curved portion 120r where bubbles may otherwise be highly likely to be generated.

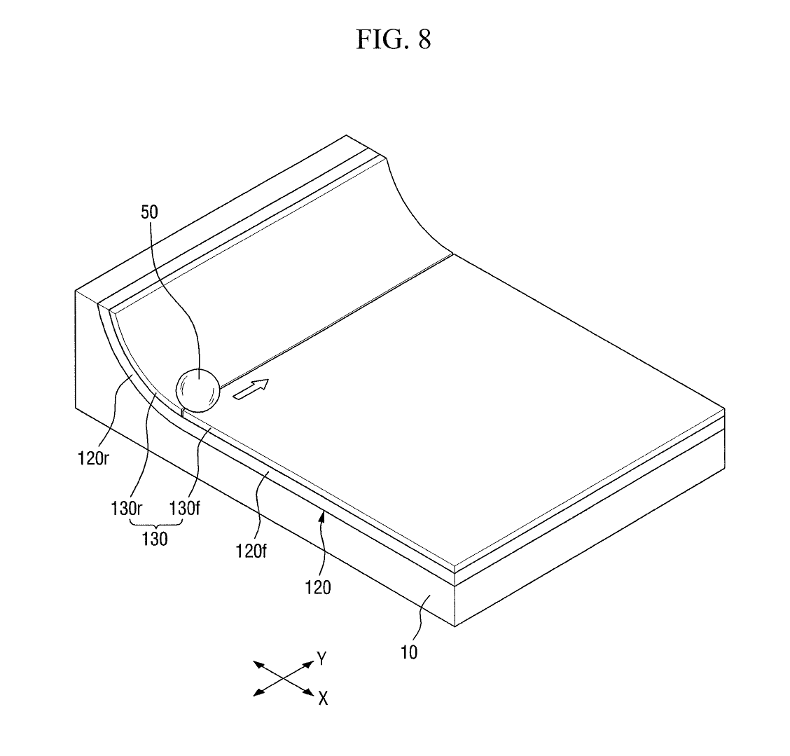

Referring to FIG. 8, a ball 50 may be moved in a second direction Y, which is perpendicular to the first direction X, so as to press a portion where the first adhesive portion 130r and the second adhesive portion 130f face each other. As a result, an interface INT1 may be formed between the first adhesive portion 130r and the second adhesive portion 130f while leaving substantially no gap between the first adhesive portion 130r and the second adhesive portion 130f. The ball 50 may have a smaller curvature (e.g., smaller radius of curvature) than the curved portion 120r, and may thus delicately and precisely press the boundary between the first adhesive portion 130r and the second adhesive portion 130f, without being interfered with by the curvature of the curved portion 120r. In an implementation, a gap may still remain between the first adhesive portion 130r and the second adhesive portion 130f, but may be minute enough to be ignored and/or may not affect the device. Another driving unit (not illustrated), e.g., a motor, may be connected to the ball 50 in order to move the ball 50.

After bonding the first adhesive portion 130r and the second adhesive portion 130f to the cover window 120, a touch panel (not illustrated) or a display panel (not illustrated) may be attached onto the first adhesive portion 130r and the second adhesive portion 130f.

As illustrated in FIGS. 3 to 9, the first adhesive portion 130r and the second adhesive portion 130f of the adhesive film 130 may be attached onto the curved portion 120r and the flat portion 120f, respectively, of the cover window 120. Accordingly, it is possible to reduce and/or prevent the generation of bubbles that could otherwise be created between the adhesive film 130 and the cover window 120 (due to a difference in the pressure applied by the roller 30 between the curved portion 120r and the flat portion 120f of the cover window 120).

In addition, it is possible to help reduce smudges that may result from the presence of such bubbles, and thus it is possible to provide a curved display device with an improved quality of display.

As illustrated in FIGS. 3 to 9, the boundary between the first adhesive portion 130r and the second adhesive portion 130f may be pressed with the ball 50. Accordingly, it is possible to leave no gap, or to minimize a gap, between the first adhesive portion 130r and the second adhesive portion 130f. Thus, it is possible to prevent the quality of display of the curved display device 100 from being degraded by an excessively large gap between the first adhesive portion 130r and the second adhesive portion 130f.

By way of summation and review, curved display devices, which are display devices that are at least partially curved and may thus be properly viewed from a variety of angles, have been considered. For example, a curved display device may be fabricated by attaching (with the use of a roller) an adhesive film onto a cover window that has a curved portion and a flat portion, and then bonding a display panel onto the adhesive film with the use of the roller.

Pressure applied by the roller may vary from the curved portion to the flat portion of the cover window, and bubbles may be created between the cover window and the adhesive film.

Such bubbles may result in smudges on a curved display device and may thus degrade the quality of display of the curved display device.

The embodiments may provide a curved display device and a method of fabricating the same, which may help prevent bubbles from being created in the curved display device.

According to the exemplary embodiments, a first adhesive portion and a second adhesive portion of an adhesive film, which may be separate from each other, may be attached onto a curved portion and a flat portion, respectively, of a cover window or of a display panel, and bubbles may be reduced between the adhesive film and the cover window or the display panel.

Therefore, it is possible to reduce smudges that may be generated by such bubbles, and thus to improve the quality of display.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A curved display device, comprising:
a display panel including a curved portion and a flat portion;
a cover window having a same shape as the display panel, the cover window being bonded to the display panel; and
an adhesive film between the display panel and the cover window,
wherein the adhesive film includes:
a first adhesive portion attached to at least the curved portion of the display panel, and
a second adhesive portion attached to the flat portion of the display panel, the second adhesive portion being a separate piece from the first adhesive portion.

2. The curved display device as claimed in claim 1, wherein the first adhesive portion and the second adhesive portion form an interface therebetween.

3. The curved display device as claimed in claim 2, wherein the interface overlaps with a boundary between the curved portion of the display panel and the flat portion of the display panel.

4. The curved display device as claimed in claim 2, wherein the interface overlaps with the flat portion at an edge portion of the flat portion that adjoins the curved portion.

5. The curved display device as claimed in claim 1, wherein the first adhesive portion and the second adhesive portion have a gap therebetween.

6. The curved display device as claimed in claim 1, wherein the adhesive film is an optical clear adhesive tape.

7. The curved display device as claimed in claim 1, wherein the display panel is a liquid crystal display panel or an organic light-emitting display panel.

8. A method of fabricating a curved display device, the method comprising:
placing a cover window on a stage, the cover window including a curved portion and a flat portion;
placing a first holder over the stage, the first holder holding a first adhesive portion;
attaching the first adhesive portion onto at least the curved portion of the cover window by moving a roller in a first direction, the first direction being parallel to a direction in which the curved portion and the flat portion are connected together;
placing a second holder over the stage, the second holder holding a second adhesive portion; and
attaching the second adhesive portion onto the flat portion by moving the roller in the first direction.

9. The method as claimed in claim 8, further comprising pressing the first adhesive portion and the second adhesive portion where the first adhesive portion and the second adhesive portion face each other, the pressing including moving a ball in a second direction perpendicular to the first direction, after attaching the second adhesive portion onto the flat portion.

10. The method as claimed in claim 9, wherein the ball has a smaller curvature than the curved portion.

11. The method as claimed in claim 8, wherein a moving speed of the roller during attaching the first adhesive portion to the cover window is slower than the moving speed of the roller during attaching the second adhesive portion to the cover window.

12. The method as claimed in claim 8, wherein a top surface of the stage has a same shape as a top surface and a bottom surface of the cover window.

13. The method as claimed in claim 8, wherein attaching the first adhesive portion and the second adhesive portion to the cover window forms an interface between the first adhesive portion and the second adhesive portion.

14. The method as claimed in claim 13, wherein the interface overlaps with a boundary between the curved portion and the flat portion.

15. The method as claimed in claim 13, wherein the interface overlaps with the flat portion at an edge portion of the flat portion that adjoins the curved portion.

16. The method as claimed in claim 8, wherein attaching the first adhesive portion and the second adhesive portion to the cover window forms a gap between the first adhesive portion and the second adhesive portion.

17. The method as claimed in claim 8, wherein the first adhesive portion and the second adhesive portion are optical clear adhesive tapes.

18. The method as claimed in claim 8, further comprising attaching a touch panel or a display panel onto the first adhesive portion and the second adhesive portion.

19. The method as claimed in claim 18, wherein the display panel is a liquid crystal display panel or an organic light-emitting display panel.
